(19) United States
(12) Patent Application Publication
(10) Pub. No.: US 2022/0022208 A1
(43) Pub. Date: Jan. 20, 2022

(54) TERMINAL APPARATUS AND BASE STATION APPARATUS

(71) Applicants: SHARP KABUSHIKI KAISHA, Sakai City, Osaka (JP); FG Innovation Company Limited, Tuen Mun (HK)

(72) Inventors: OSAMU NAKAMURA, Sakai City, Osaka (JP); YASUHIRO HAMAGUCHI, Sakai City, Osaka (JP)

(21) Appl. No.: 17/299,990

(22) PCT Filed: Dec. 23, 2019
(86) PCT No.: PCT/JP2019/050425

§ 371 Date: Jun. 4, 2021

(30) Foreign Application Priority Data
Dec. 28, 2018 (JP) 2018-247863

(51) Int. Cl. H04W 72/12; H04L 5/00; H04W 72/14

(52) U.S. Cl. CPC H04W 72/1231; H04L 5/0082; H04W 72/14; H04L 5/0051

(57) ABSTRACT

Efficient transmission is performed in a case that an allocation periodicity is shorter than an interval based on repeated transmission. For configuration grant scheduling, in a case that the allocation periodicity is shorter than the interval based on the repeated transmission, a port number for a DMRS is determined according to the number of repetitions to allow a base station apparatus to determine which periodicity corresponds to the start of the transmission. Thus, by detecting the port number for the DMRS, the base station apparatus can recognize the start or the end of the transmission by the terminal apparatus.

### TECHNICAL FIELD

The present invention relates to a terminal apparatus and a base station apparatus. This application claims priority based on JP 2018-247863 filed on Dec. 28, 2018, the contents of which are incorporated herein by reference.

### BACKGROUND ART

For a Long Term Evolution (LTE) communication system standardized by Third Generation Partnership Project (3GPP), dynamic scheduling is specified in which DCI (Downlink Control Information (grant)) is notified from a base station apparatus to a terminal apparatus such that data transmission is performed based on the notified DCI. In the dynamic scheduling, reception of one piece of DCI causes one transmission to be performed. On the other hand, in addition to the dynamic scheduling, Semi-Persistent Scheduling (SPS) is specified in which radio resources are periodically allocated. In SPS, even in a case that one piece of DCI is received, the periodic allocation of radio resources is performed, thus allowing for multiple data transmissions.

In 3GPP, standardization of fifth generation mobile communication (New Radio, NR) is under way with use cases specified as enhanced Mobile Broad Band (eMBB), Ultra-Reliable and Low Latency Communications (URLLC), and massive Machine-Type Communications (mMTC). For NR Rel-15, Configured scheduling (CS) is specified that corresponds to enhanced LTE SPS. The CS enables transmission in repeated slots, allowing reliability of the transmission to be improved.

For Rel-16, studies have been under way by 3GPP to achieve improved reliability (packet reception success rate of 99.9999%) and reduced delay (delay of from 0.5 ms to 1 ms) (NPL 1).

Rel-15 specifies that a periodicity P of resources allocated by a CS and the number of repeated transmissions K are configured to avoid P<K. However, a proposal has been made to eliminate this limitation in Rel-16 in order to achieve reduced delay and improved reliability (NPL 2). This allows the number of repetitions to be increased compared to Rel-15 with the number of transmission opportunities maintained.

### CITATION LIST

### Non Patent Literature

NPL 1: Huawei, HiSilicon, Nokia, Nokia Shanghai Bell, “SID on Physical Layer Enhancements for NR URLLC”, RP-181477.
Non-Patent Document 2: Ericsson, “Enhancement of Configured Grant for NR URLLC”, R1-1812162.

### SUMMARY OF INVENTION

### Technical Problem

Although the proposal has been made that Rel-16 eliminate the limitation in which P<K is avoided, no possible problems caused by the elimination of the limitation have been disclosed and no studies of countermeasures have been under way.

In view of such circumstances, an object of the present invention is to provide a method for performing transmission without any problem even in a case that the limitation in which P<K is avoided is eliminated.

### Solution to Problem

To achieve the above-mentioned object, a base station apparatus, a terminal apparatus, and a communication method according to the present invention are configured as follows.

(1) One aspect of the present invention provides a terminal apparatus for communicating with a base station apparatus through configured grant scheduling, the terminal apparatus including: a higher layer processing unit configured to configure higher layer signaling using at least the number of repetitions and an allocation periodicity as parameters for the configured grant scheduling; and a transmitter configured to transmit a demodulation reference signal (DMRS), wherein the transmitter determines a port number for the DMRS based on a current number of repetitions.

(2) In one aspect of the present invention, the transmitter determines the port number for the DMRS based on the current number of repetitions and a slot index.

(3) In one aspect of the present invention, the transmitter performs transmission until the current number of repetitions reaches the number of repetitions.

(4) One aspect of the present invention is a base station apparatus for communicating with a terminal apparatus through configured grant scheduling, the base station apparatus including: a higher layer processing unit configured to configure higher layer signaling using at least the number of repetitions and an allocation periodicity as parameters for the configured grant scheduling; and a receiver configured to receive a demodulation reference signal (DMRS), wherein the receiver performs reception processing assuming that a port number for the DMRS is determined based on a current number of repetitions.

(5) In one aspect of the present invention, the receiver determines the port number for the DMRS based on the current number of repetitions and a slot index of the terminal apparatus.

(6) In one aspect of the present invention, the receiver performs reception until the current number of repetitions reaches the number of repetitions of the terminal apparatus.

### Advantageous Effects of Invention

According to one or more aspects of the present invention, the base station apparatus and the terminal apparatus can perform transmission without any problem even in a case that the limitation in which P<K is avoided is eliminated.

### BRIEF DESCRIPTION OF DRAWINGS

FIG. 1 is a diagram illustrating a configuration example of a communication system 1 according to the present embodiment.

FIG. 2 is a diagram illustrating a configuration example of a base station apparatus according to the present embodiment.

FIG. 3 is a diagram illustrating a configuration example of a terminal apparatus according to the present embodiment.

FIG. 4 is a diagram illustrating transmission opportunities in a case of periodicity being one slot and the number of repetitions corresponding to four slots according to the present embodiment.

FIG. 5 is a diagram illustrating the end of transmission opportunities in a case that prescribed slots are transmitted according to the present embodiment.

### DESCRIPTION OF EMBODIMENTS

A communication system according to the present embodiments includes a base station apparatus (a cell, a small cell, a serving cell, a component carrier, an eNodeB, a Home eNodeB, and a gNodeB) and a terminal apparatus (a terminal, a mobile terminal, and User Equipment (UE)). In the communication system, in a case of a downlink, the base station apparatus serves as a transmitting apparatus (a transmission point, a transmit antenna group, a transmit antenna port group, or a Tx/Rx Point (TRP)), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D, sidelink) communication. In this case, the terminal apparatus serves both as a transmitting apparatus and as a receiving apparatus.

The communication system is not limited to a system limited to data communication between a terminal apparatus and a base station apparatus, the data communication involving intervention of human beings. The communication system can be applied to forms of data communication involving no intervention of human beings, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). In a case that a higher layer parameter related to a transform precoder is configured in the uplink, the communication system uses a transmission scheme such as a Discrete Fourier Transform Spread-Orthogonal Frequency Division Multiplexing (DFTS-OFDM, also referred to as an SC-FDMA) which employs Transform precoding, in other words, employs DFT. Although the following describes a case of using an OFDM transmission scheme in the uplink and the downlink, the transmission scheme is not limited to this and another transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band.

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

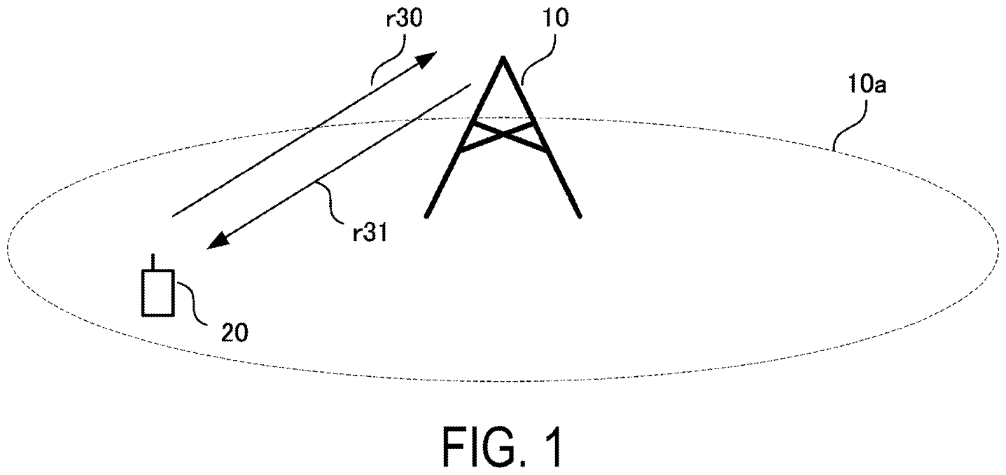

FIG. 1 is a diagram illustrating a configuration example of a communication system 1 according to the present embodiment. The communication system 1 according to the present embodiment includes a base station apparatus 10 and a terminal apparatus 20. Coverage 10a is a range (a communication area) in which the base station apparatus 10 can connect to the terminal apparatus 20 (coverage 10a is also referred to as a cell). Note that the base station apparatus 10 can accommodate multiple terminal apparatuses 20 in the coverage 10a.

In FIG. 1, an uplink radio communication r30 at least includes the following uplink physical channels. The uplink physical channels are used for transmitting information output from a higher layer.

Physical Uplink Control Channel (PUCCH)

Physical Uplink Shared Channel (PUSCH)

Physical Random Access Channel (PRACH)

The PUCCH is a physical channel that is used to transmit Uplink Control Information (UCI). The Uplink Control Information includes a positive acknowledgement (ACK)/Negative acknowledgement (NACK) for downlink data. In this regard, downlink data refers to Downlink transport block, Medium Access Control Protocol Data Unit: MAC PDU, Downlink-Shared Channel: DL-SCH, Physical Downlink Shared Channel: PDSCH, and the like. The ACK/NACK is also referred to as a Hybrid Automatic Repeat request ACKnowledgement (HARQ-ACK), a HARQ feedback, a HARQ response, or a signal indicating HARQ control information or a delivery confirmation.

NR supports at least five formats: PUCCH format 0, PUCCH format 1, PUCCH format 2, PUCCH format 3, and PUCCH format 4. PUCCH format 0 and PUCCH format 2 each include one or two OFDM symbols, and the other PUCCHs each include 4 to 14 OFDM symbols. PUCCH format 0 and PUCCH format 1 include a bandwidth of 12 subcarriers. Additionally, in PUCCH format 0, a 1-bit (or 2-bit) ACK/NACK is transmitted in resource elements of 12 subcarriers and 1 OFDM symbol (or 2 OFDM symbols).

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel.

In NR, higher layer parameter RI limitation can be configured. The RI limitation includes multiple configuration parameters, and one of the configuration parameters is type 1 single panel RI limitation and includes 8 bits. The type 1 single panel RI limitation that is a bitmap parameter forms a bit sequence r₇, . . . , r₂, r₁. Here, r₇ is a Most Significant Bit (MSB), and r₀ is a Least Significant Bit (LSB). In a case that rᵢ is zero (i is 0, 1, . . . 7), the PMI and RI reporting corresponding to a precoder associated with the i+1 layer are not allowed. Besides the type 1 single panel, the RI limitation includes type 1 multi-panel RI limitation, which includes four bits. The multi-panel RI restriction that is bitmap parameter type 1 forms bit sequences r₄, r₃, r₂, and r₁. Here, r₄ is the MSB, and r₀ is the LSB. In a case that rᵢ is zero (i is 0, 1, 2, 3), the PMI and RI reporting corresponding to the precoder associated with the i+1 layer are not allowed.

The CQI can use an index (CQI index) indicative of a preferable modulation scheme (for example, QPSK, 16QAM, 64QAM, 256QAMAM, or the like), a preferable coding rate, and a preferable frequency utilization efficiency in a predetermined band. The terminal apparatus selects, from the CQI table, a CQI index considered to allow the transport block of the PDSCH to be received without exceeding a block error rate (BLER)=0.1. However, in a case that a prescribed CQI table is configured through higher layer signaling, a CQI index considered to allow for reception without exceeding a BLER=0.00001 is selected from the CQI table.

The PUSCH is a physical channel used to transmit uplink data (an Uplink Transport Block, an Uplink-Shared Channel (UL-SCH)), and CP-OFDM or DFT-S-OFDM is applied as a transmission scheme. The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment specific (user equipment unique) information is transmitted using the signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a power headroom may be included in MAC CE and may be reported via the PUSCH. In other words, a MAC CE field is used to indicate a level of the power headroom. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used to transmit a random access preamble. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink reference signal includes a Demodulation Reference Signal (DMRS), a Sounding Reference Signal (SRS), a Phase Tracking Reference Signal (PTRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/the physical uplink control channel.

The SRS is not associated with the transmission of the physical uplink shared channel/the physical uplink control channel. The base station apparatus 10 uses the SRS to measure an uplink channel state (CSI Measurement).

The PTRS is associated with transmission of the physical uplink-shared channel/physical uplink control channel. The base station apparatus 10 uses the SRS for phase tracking.

In FIG. 1, at least the following downlink physical channels are used in radio communication of the downlink r31. The downlink physical channels are used for transmitting information output from the higher layer.

Physical Broadcast Channel (PBCH)

Physical Downlink Control Channel (PDCCH)

Physical Downlink Shared Channel (PDSCH)

The PBCH is used for broadcasting a Master Information Block (MIB, a Broadcast CHannel (BCH)) that is used commonly by the terminal apparatuses. The MIB is one of pieces of system information. For example, the MIB includes a downlink transmission bandwidth configuration and a System Frame Number (SFN). The MIB may include information indicating at least some of numbers of a slot, a subframe, and a radio frame in which a PBCH is transmitted.

The PDCCH is used to transmit downlink control information (DCI). For the downlink control information, multiple formats based on applications (also referred to as DCI formats) are defined. The DCI format may be defined based on the type and the number of bits of the DCI constituting a single DCI format. Each format is used depending on the application. The downlink control information includes control information for downlink data transmission and control information for uplink data transmission. The DCI format for downlink data transmission is also referred to as downlink assignment (or downlink grant). The DCI format for uplink data transmission is also referred to as uplink grant (or uplink assignment).

A single downlink assignment is used for scheduling a single PDSCH in a single serving cell. The downlink grant may be used for at least scheduling of the PDSCH within the same slot as the slot in which the downlink grant has been transmitted. The downlink assignment includes downlink control information such as a frequency domain resource allocation and time domain resource allocation for the PDSCH, a Modulation and Coding Scheme (MCS) for the PDSCH, a NEW Data Indicator (NDI) indicating initial transmission or retransmission, information indicating an HARQ process number in the downlink, and a Redundancy version indicating the amount of redundancy added to the codeword during error correction coding. The codeword is data after the error correcting coding. The downlink assignment may include a Transmission Power Control (TPC) command for the PUCCH and a TPC command for the PUSCH. The uplink grant may include a Repetition number for indicating the number of repetitions for transmission of the PUSCH. Note that the DCI format for each downlink data transmission includes information (fields) required for the application among the above-described information.

A single uplink grant is used for notifying the terminal apparatus of scheduling of a single PUSCH in a single serving cell. The uplink grant includes uplink control information such as information related to the resource block allocation for transmission of the PUSCH (resource block allocation and hopping resource allocation), time domain resource allocation, information related to the MCS for the PUSCH (MCS/Redundancy version), information related to a DMRS port, information related to retransmission of the PUSCH, a TPC command for the PUSCH, and a request for downlink Channel State Information (CSI)(CSI request). The uplink grant may include information indicating the HARQ process number in the uplink, a Transmission Power Control (TPC) command for the PUCCH, and a TPC command for the PUSCH. Note that the DCI format for each uplink data transmission includes information (fields) required for the application among the above-described information.

In a case that intra frequency hopping is not applied and a PUSCH mapping type A is used, an OFDM symbol number (position) for transmitting a DMRS symbol is given by the period of signaling between the OFDM symbol at the start of the slot and the OFDM symbol at the end of the PUSCH resource scheduled in the slot. In a case that the intra-frequency hopping is not applied and that a PUSCH mapping type B is used, the OFDM symbol number is given by the period of the scheduled PUSCH resource. In a case that the intra-frequency hopping is applied, the OFDM symbol number is given by a period per hop. For the PUSCH mapping type A, only in a case that the higher layer parameter indicating the position of the leading DMRS is 2, a case where the higher layer parameter indicating the number of DMRSs to be added is 3 is supported. For the PUSCH mapping type A, a 4 symbol period is only applicable in a case that the higher layer parameter indicating the position of the leading DMRS is 2.

The PDCCH is generated by adding a Cyclic Redundancy Check (CRC) to the downlink control information. In the PDCCH, CRC parity bits are scrambled with a predetermined identifier (also referred to as an exclusive OR operation, mask). The parity bits are scrambled with a Cell-Radio Network Temporary Identifier (C-RNTI), a Configured Scheduling (CS)-RNTI, Temporary C-RNTI, Paging (P)-RNTI, a System Information (SI)-RNTI, or a Random Access (RA)-RNTI, a Semi-Persistent Channel State-Information (SP-CSI)-RNTI, or MCS-C-RNTI. The C-RNTI and the CS-RNTI are identifiers for identifying a terminal apparatus within a cell. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. Here, the PDCCH (DCI format) scrambled with the CS-RNTI is used to activate or deactivate CS type 2. On the other hand, in CS type 1, control information (MCS, radio resource allocation, and the like) included in the PDCCH scrambled with the CS-RNTI in CS type 1 is included in the higher layer parameter related to the CS, and the higher layer parameter is used to activate (configure) the CS. The P-RNTI is used to transmit a paging message (Paging Channel (PCH)). The SI-RNTI is used to transmit an SIB. The RA-RNTI is used to transmit a random access response (message 2 in a random access procedure). The SP-CSI-RNTI is used for semi-static CSI reporting. The MCS-C-RNTI is used in selecting an MCS table with low spectral efficiency.

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using the RRC signaling unique to the cell. The RRC signaling transmitted from the base station apparatus may be a message dedicated to a certain terminal apparatus (also referred to as dedicated signaling). In other words, user equipment specific (user equipment unique) information is transmitted by using the message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization Signal (SS) and a Downlink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

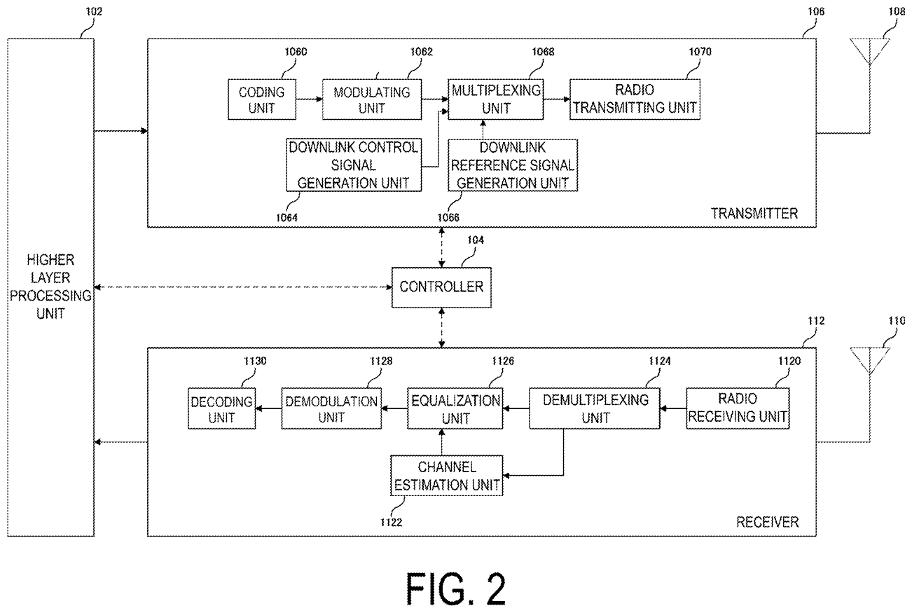

FIG. 2 is a schematic block diagram of a configuration of the base station apparatus 10 according to the present embodiment. The base station apparatus 10 includes a higher layer processing unit (higher layer processing step) 102, a controller (control step) 104, a transmitter (transmitting step) 106, a transmit antenna 108, a receive antenna 110, and a receiver (receiving step) 112. The transmitter 106 generates the physical downlink channel in accordance with a logical channel input from the higher layer processing unit 102. The transmitter 106 is configured to include a coding unit (coding step) 1060, a modulating unit (modulating step) 1062, a downlink control signal generation unit (downlink control signal generating step) 1064, a downlink reference signal generation unit (downlink reference signal generating step) 1066, a multiplexing unit (multiplexing step) 1068, and a radio transmitting unit (radio transmitting step) 1070. The receiver 112 detects (demodulates, decodes, or the like) the physical uplink channel and inputs the content to the higher layer processing unit 102. The receiver 112 is configured to include a radio receiving unit (radio receiving step) 1120, a channel estimation unit (channel estimating step) 1122, a demultiplexing unit (demultiplexing step) 1124, an equalization unit (equalizing step) 1126, a demodulation unit (demodulating step) 1128, and a decoding unit (decoding step) 1130.

The higher layer processing unit 102 performs processing on a layer, such as a Medium Access Control (MAC) layer, a Packet Data Convergence Protocol (PDCP) layer, a Radio Link Control (RLC) layer, and a Radio Resource Control (RRC) layer, that is higher than the physical layer. The higher layer processing unit 102 generates information required to control the transmitter 106 and the receiver 112, and outputs the resultant information to the controller 104. The higher layer processing unit 102 outputs the downlink data (such as DL-SCH), the system information (MIB, SIB), and the like to the transmitter 106. Note that the DMRS configuration information may be notified to the terminal apparatus by using the system information (MIB or SIB), instead of the notification by using the higher layer such as RRC.

The higher layer processing unit 102 generates, or acquires from a higher node, the system information (a part of the MIB or the SIB) to be broadcasted. The higher layer processing unit 102 outputs the system information to be broadcasted to the transmitter 106 as BCH/DL-SCH. The MIB is allocated to the PBCH in the transmitter 106. The SIB is allocated to the PDSCH in the transmitter 106. The higher layer processing unit 102 generates, or acquires from a higher node, the system information (SIB) specific to the terminal apparatus. The SIB is allocated to the PDSCH in the transmitter 106.

The higher layer processing unit 102 configures various RNTIs for each terminal apparatus. The RNTI is used for encryption (scrambling) of the PDCCH, the PDSCH, and the like. The higher layer processing unit 102 outputs the RNTI to the controller 104/the transmitter 106/the receiver 112.

In a case that the downlink data (transport block, DL-SCH) allocated to the PDSCH, the system information specific to the terminal apparatus (System Information Block: SIB), the RRC message, the MAC CE, and the DMRS configuration information are not notified by using the system information, such as the SIB and the MIB, and the DCI, the higher layer processing unit 102 generates, or acquires from a higher node, the DMRS configuration information or the like and outputs the information generated or acquired to the transmitter 106. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the receiver 112). The terminal apparatus 20 transmits its own function to the base station apparatus 10 by a higher layer signaling (RRC signaling). The information on the terminal apparatus includes information for indicating whether the terminal apparatus supports a predetermined function or information for indicating that the terminal apparatus has completed introduction and testing of the predetermined function. The information for indicating whether the predetermined function is supported includes information for indicating whether the introduction and testing of the predetermined function have been completed.

In a case that the terminal apparatus supports the predetermined function, the terminal apparatus transmits information (parameters) for indicating whether the predetermined function is supported. In a case that the terminal apparatus does not support the predetermined function, the terminal apparatus may be configured not to transmit information (parameters) for indicating whether the predetermined function is supported. In other words, whether the predetermined function is supported is notified by whether information (parameters) for indicating whether the predetermined function is supported is transmitted. The information (parameters) for indicating whether the predetermined function is supported may be notified by using one bit of 1 or 0.

The higher layer processing unit 102 acquires the DL-SCH from the decoded uplink data (including the CRC) from the receiver 112. The higher layer processing unit 102 performs error detection on the uplink data transmitted by the terminal apparatus. For example, the error detection is performed in the MAC layer.

The controller 104 controls the transmitter 106 and the receiver 112 based on the various kinds of configuration information input from the higher layer processing unit 102/receiver 112. The controller 104 generates the downlink control information (DCI) based on the configuration information input from the higher layer processing unit 102/receiver 112, and outputs the generated downlink control information to the transmitter 106. For example, the controller 104 configures, based on the configuration information on the DMRS input from the higher layer processing unit 102/receiver 112 (whether the configuration is the DMRS configuration 1 or the DMRS configuration 2), the frequency allocation of the DMRS (an even subcarrier or an odd subcarrier in the case of DMRS configuration 1, and any of the zeroth to the second sets in the case of the DMRS configuration 2), and generates the DCI.

The controller 104 determines the MCS of the PUSCH in consideration of channel quality information (CSI Measurement result) measured by the channel estimation unit 1122. The controller 104 determines an MCS index corresponding to the MCS of the PUSCH. The controller 104 includes, in the uplink grant, the MCS index determined.

The transmitter 106 generates the PBCH, the PDCCH, the PDSCH, the downlink reference signal, and the like in accordance with the signal input from the higher layer processing unit 102/controller 104. The coding unit 1060 performs encoding (including repetition) using block code, convolutional code, turbo code, polar coding, LDPC code, or the like on the BCH, the DL-SCH, and the like input from the higher layer processing unit 102 by using a predetermined coding scheme/a coding scheme determined by the higher layer processing unit 102. The coding unit 1060 performs puncturing on the coded bits based on the coding rate input from the controller 104. The modulating unit 1062 performs data modulation on the coded bits input from the coding unit 1060 by using a predetermined modulation scheme (modulation order)/a modulation scheme (modulation order) input from the controller 104, such as the BPSK, QPSK, 16QAM, 64QAM, or 256QAM. The modulation order is based on the MCS index selected by the controller 104.

The downlink control signal generation unit 1064 adds the CRC to the DCI input from the controller 104. The downlink control signal generation unit 1064 encrypts (scrambles) the CRC by using the RNTI. Furthermore, the downlink control signal generation unit 1064 performs QPSK modulation on the DCI to which the CRC is added, and generates the PDCCH. The downlink reference signal generation unit 1066 generates a sequence known to the terminal apparatus as a downlink reference signal. The known sequence is determined by a predetermined rule based on a physical cell identity for identifying the base station apparatus 10 and the like.

The multiplexing unit 1068 multiplexes the PDCCHs/downlink reference signals/modulation symbols of the respective channels input from the modulating unit 1062. In other words, the multiplexing unit 1068 maps the PDCCHs/downlink reference signals/modulation symbols of the respective channels to the resource elements. The resource elements to which the mapping is performed are controlled by downlink scheduling input from the controller 104. The resource element is the minimum unit of a physical resource including one OFDM symbol and one subcarrier. Note that, in a case of performing MIMO transmission, the transmitter 106 includes the coding units 1060 and the modulating units 1062. Each of the number of the coding units 1060 and the number of the modulating units 1062 is equal to the number of layers. In this case, the higher layer processing unit 102 configures the MCS for each transport block in each layer.

The radio transmitting unit 1070 performs Inverse Fast Fourier Transform (IFFT) on the multiplexed modulation symbols and the like to generate OFDM symbols. The radio transmitting unit 1070 adds cyclic prefixes (CPs) to the OFDM symbols to generate a baseband digital signal. Furthermore, the radio transmitting unit 1070 converts the digital signal into an analog signal, removes unnecessary frequency components from the analog signal by filtering, performs up-conversion to a signal of a carrier frequency, performs power amplification, and outputs the resultant signal to the transmit antenna 108 for transmission.

In accordance with an indication from the controller 104, the receiver 112 detects (separates, demodulates, and decodes) the reception signal received from the terminal apparatus 20 through the receive antenna 110, and inputs the decoded data to the higher layer processing unit 102/controller 104. The radio receiving unit 1120 converts the uplink signal received through the receive antenna 110 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The radio receiving unit 1120 performs Fast Fourier Transform (FFT) on the signal from which the CPs have been removed, and extracts a signal in the frequency domain. The signal in the frequency domain is output to the demultiplexing unit 1124.

The demultiplexing unit 1124 demultiplexes the signals input from the radio receiving unit 1120 into signals, such as the PUSCH, the PUCCH, and the uplink reference signal, based on uplink scheduling information (such as uplink data channel allocation information) input from the controller 104. The uplink reference signal resulting from the demultiplexing is input to the channel estimation unit 1122. The PUSCH and PUCCH resulting from the demultiplexing are output to the equalization unit 1126.

The channel estimation unit 1122 uses the uplink reference signal to estimate a frequency response (or a delay profile). The result of frequency response in the channel estimation for demodulation is input to the equalization unit 1126. The channel estimation unit 1122 measures the uplink channel condition (measures a Reference Signal Received Power (RSRP), a Reference Signal Received Quality (RSRQ), and a Received Signal Strength Indicator (RSSI)) by using the uplink reference signal. The measurement of the uplink channel state is used to determine the MCS for the PUSCH and the like.

The equalization unit 1126 performs processing to compensate for an influence in a channel based on the frequency response input from the channel estimation unit 1122. As a method for the compensation, any existing channel compensation, such as a method of multiplying an MMSE weight or an MRC weight and a method of applying an MLD, is applicable. The demodulation unit 1128 performs demodulation processing based on the information on a predetermined modulation scheme/modulation scheme indicated by the controller 104.

The decoding unit 1130 performs decoding processing on the output signal from the demodulation unit based on the information on a predetermined coding rate/coding rate indicated by the controller 104. The decoding unit 1130 inputs the decoded data (such as the UL-SCH) to the higher layer processing unit 102.

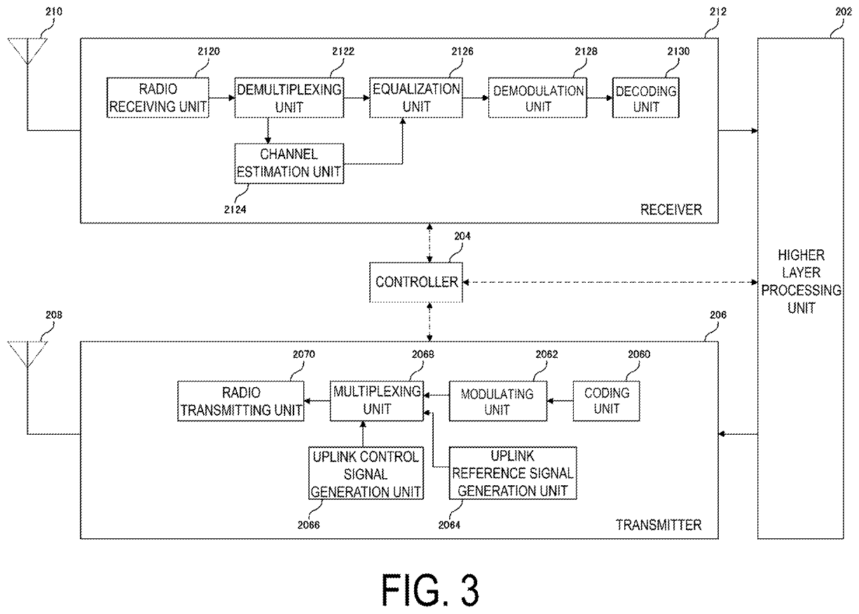

FIG. 3 is a schematic block diagram illustrating a configuration of the terminal apparatus 20 according to the present embodiment. The terminal apparatus 20 is configured to include a higher layer processing unit (higher layer processing step) 202, a controller (control step) 204, a transmitter (transmitting step) 206, a transmit antenna 208, a receive antenna 210, and a receiver (receiving step) 212.

The higher layer processing unit 202 performs processing of the medium access control (MAC) layer, the packet data convergence protocol (PDCP) layer, the radio link control (RLC) layer, and the radio resource control (RRC) layer. The higher layer processing unit 202 manages various kinds of configuration information of the terminal apparatus itself. The higher layer processing unit 202 notifies the base station apparatus 10 of information for indicating terminal apparatus functions supported by the terminal apparatus itself (UE Capability) via the transmitter 206. The higher layer processing unit 202 notifies the UE Capability by RRC signaling.

The higher layer processing unit 202 acquires the decoded data, such as the DL-SCH and the BCH, from the receiver 212. The higher layer processing unit 202 generates the HARQ-ACK from a result of the error detection of the DL-SCH. The higher layer processing unit 202 generates the SR. The higher layer processing unit 202 generates the UCI including the HARQ-ACK/SR/CSI (including the CQI report). In a case that the DMRS configuration information is notified by the higher layer, the higher layer processing unit 202 inputs the information on the DMRS configuration to the controller 204. The higher layer processing unit 202 inputs the UCI and the UL-SCH to the transmitter 206. Note that some functions of the higher layer processing unit 202 may be included in the controller 204.

The controller 204 interprets the downlink control information (DCI) received via the receiver 212. The controller 204 controls the transmitter 206 in accordance with PUSCH scheduling/MCS index/Transmission Power Control (TPC), and the like acquired from the DCI for uplink transmission. The controller 204 controls the receiver 212 in accordance with the PDSCH scheduling/the MCS index and the like acquired from the DCI for downlink transmission. Furthermore, the controller 204 identifies the frequency allocation (port number) of the DMRS according to the information on the frequency allocation of the DMRS included in the DCI for downlink transmission and the DMRS configuration information input from the higher layer processing unit 202.

The transmitter 206 is configured to include a coding unit (coding step) 2060, a modulating unit (modulating step) 2062, an uplink reference signal generation unit (uplink reference signal generating step) 2064, an uplink control signal generation unit (uplink control signal generating step) 2066, a multiplexing unit (multiplexing step) 2068, and a radio transmitting unit (radio transmitting step) 2070.

In accordance with the control by the controller 204 (in accordance with the coding rate calculated based on the MCS index), the coding unit 2060 codes the uplink data (UL-SCH) input from the higher layer processing unit 202 by convolutional coding, block coding, turbo coding, or the like.

The modulating unit 2062 modulates the coded bits input from the coding unit 2060 (generates modulation symbols for the PUSCH) by a modulation scheme indicated from the controller 204/modulation scheme predetermined for each channel, such as BPSK, QPSK, 16QAM, 64QAM, and 256QAM.

The uplink reference signal generation unit 2064 generates a sequence determined from a predetermined rule (formula), based on a physical cell identity (PCI), which is also referred to as a Cell ID, or the like, for identifying the base station apparatus 10, a bandwidth in which the uplink reference signals are mapped, a cyclic shift, parameter values to generate the DMRS sequence, further the frequency allocation, and the like, in accordance with an indication by the controller 204.

In accordance with the indication from the controller 204, the uplink control signal generation unit 2066 encodes the UCI, performs the BPSK/QPSK modulation, and generates modulation symbols for the PUCCH.

In a case that the higher layer parameter (frequencyHopping) related to the frequency hopping in Rel-15 is configured, mode 1 or mode 2 can be configured as a value for the parameter. Mode 2 is a mode that corresponds to inter-slot hopping and in which in a case that multiple slots are used for transmission, the frequency is changed for each slot. On the other hand, mode 1 corresponds to intra-slot hopping, and in a case that one or multiple slots are used for transmission, the slots are divided into the first half and the second half, and the frequency is changed between the first half and the second half for transmission. For frequency allocation in frequency hopping, radio resource allocation in the frequency domain notified by the DCI or RRC is applied to a first hop, and the frequency allocation for a second hop corresponds to the radio resource used for the first hop being shifted by a value configured by the higher layer parameter (frequencyHoppingOffset) related to the amount of frequency hopping amount.

In accordance with the uplink scheduling information from the controller 204 (transmission interval in the Configured Scheduling (CS) for the uplink included in the RRC message, frequency domain and time domain resource allocation included in the DCI, and the like), the multiplexing unit 2068 multiplexes the modulation symbols for the PUSCH, the modulation symbols for the PUCCH, and the uplink reference signals for each transmit antenna port (DMRS port) (in other words, the respective signals are mapped to the resource elements).

Now, configured grant scheduling (CS) will be described. Two types of transmission without dynamic grant are available. One of the types is configured grant type 1 provided by the RRC and stored as configured grant, and the other is configured grant type 2 provided by the PDCCH and stored as configured grant based on L1 signaling indicating configured grant activation or deactivation and cleared. Type 1 and type 2 are configured by the RRC for each serving cell and for each BWP. Multiple configurations may simultaneously be active in different serving cells. For type 2, the serving cells are independently activated and deactivated. For the same serving cell, the MAC entity is configured by using either type 1 or type 2. In a case that type 1 is configured, the RRC configures the following parameters:

cs-RNTI: CS-RNTI for retransmission

periodicity: periodicity of configured grant Type 1

timeDomainOffset: offset of resources related to SFN=0 in the time domain

timeDomainAllocation: allocation of configured grant in the time domain including the parameter startSymbolAndLength

nrofHARQ-Processes: the number of HARQ processes

In a case that type 2 is configured, the RRC configures the following parameters.

cs-RNTI: CS-RNTI for activation, deactivation, and retransmission

periodicity: periodicity of configured grant type 2

nrofHARQ-Processes: the number of HARQ processes

In other words, ConfiguredGrantConfig is used to configure uplink transmission without dynamic grant in accordance with two schemes. The actual uplink grant is configured via the RRC for Configured Grant Type 1, and via the PDCCH processed by the CS-RNTI for Configured Grant Type 2.

A parameter repK configured by the higher layer defines the number of repetitions applied to the transmitted transport block. repK-RV indicates a repeatedly applied redundancy version pattern. For the n-th transmission opportunity during K repetitions, the transmission associated with the (mod(n−1, 4)+1)-th value in a configured RV sequence (redundancy version pattern) is performed. In a case that the RV sequence to be configured is {0, 2, 3, 1}, the initial transmission of one transport block is started on the first transmission opportunity during the K repetitions. In a case that the RV sequence to be configured is {0, 3, 0, 3}, the initial transmission is started on any transmission opportunity during the K repetitions associated with RV=0. In a case that the RV sequence to be configured is {0, 0, 0, 0}, the initial transmission is started on any transmission opportunity during the K repetitions other than the last transmission opportunity at K=8. Any RV sequences are terminated in one of the following cases: after transmission is repeated K times, or on the last transmission opportunity during the K repetitions within a periodicity P, or in a case that uplink grant for scheduling the same transport block is received within the periodicity P. In Rel-15, the terminal apparatus does not expect configuration of a time period that is related to K-repetition transmission and that is longer than the time period calculated based on the periodicity P. For both type 1 and type 2 PUSCH transmissions based on the configured grant, in a case that repK>1 is configured, the terminal apparatus repeats the transport block over repK consecutive slots. At this time, the terminal apparatus employs the same symbol allocation in each slot. In a case that the procedure of the terminal apparatus for determining the slot configuration determines (decides) the symbols of an allocated slot as downlink symbols, the transmission in the slot is omitted for the PUSCH transmission in multiple slots. In a case that repK is configured, one of the values of once, twice, four times, and eight times can be configured. However, in a case that the RRC parameter itself is not present, the transmission is performed with the number of repetitions being 1. One of {0, 2, 3, 1}, {0, 3, 0, 3}, and {0, 0, 0, 0} is configured for repK-RV. Note that signals in different redundancy versions generated from the same transport block are signals including the same transport block (information bit sequence) but differ from one another in at least some of the coded bits constituting the sequence.

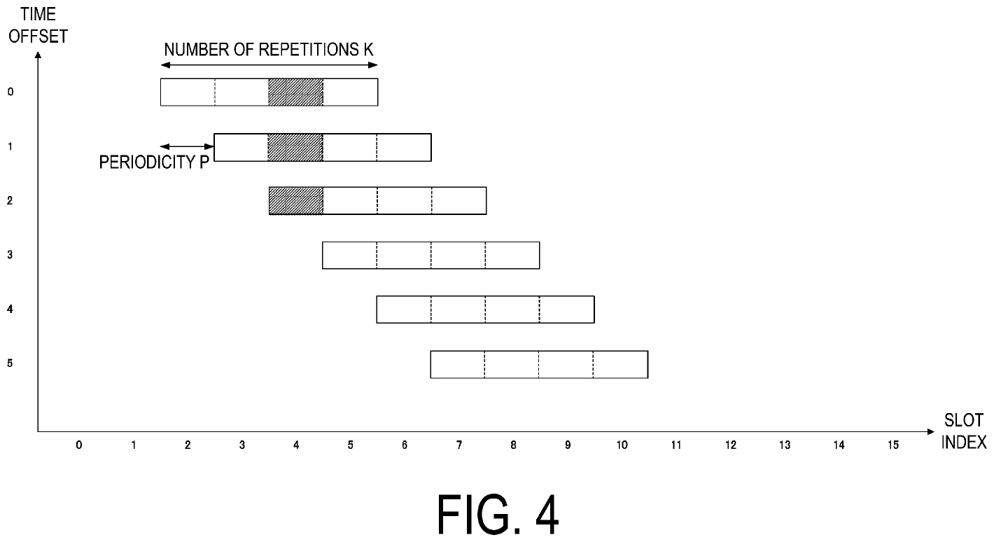

In Rel-16, it is conceivable that the terminal apparatus assumes configuration of a time period that is related to K-repetition transmission and that is longer than the time period calculated based on the periodicity P. FIG. 4 illustrates slots that can be transmitted in a case of K>P. In FIG. 4, the periodicity P is one slot, and the number of repetitions K is four. Note that FIG. 4 premises allocation in slot units but that the slot configuration may be such that transmission is repeated within one slot. In a case that the signal is successfully detected at slot index 4, the base station cannot determine whether the base station has successfully detected the third signal after the start of transmission with a time offset of 0 by the terminal apparatus, or the base station has successfully detected the second signal after the start of transmission with a time offset of 1 by the terminal apparatus, or the base station has successfully detected the first signal after the start of transmission with a time offset of 2 by the terminal apparatus. Thus, it is assumed that, to allow the base station apparatus to determine which periodicity (constitution, configuration) is used for the transmission, the port number in the DMRS transmitted by the terminal apparatus is changed. For example, by changing the DMRS port number according to the index of the transmission slot, the base station apparatus can identify the periodicity (constitution, configuration) that is used for the transmission of the PUSCH. This allows the base station apparatus to determine the time when the transmission of the terminal apparatus terminates. The port number for the DMRS may be changed according to the current number of repetitions or both the slot index and the current number of repetitions instead of the slot index. Furthermore, for the port number for the DMRS changed, limitation may be applied to the port number through higher layer signaling or the like rather than changing all possible port numbers on the system. Thus, the base station apparatus can easily allocate different DMRS ports among the terminal apparatuses, and scheduling loads can be reduced. Note that the current number of repetitions is not necessarily the number of transmissions performed by the terminal apparatus, and in a case that the terminal apparatus skips transmission, the skip is counted based on the allocation provided by the system.

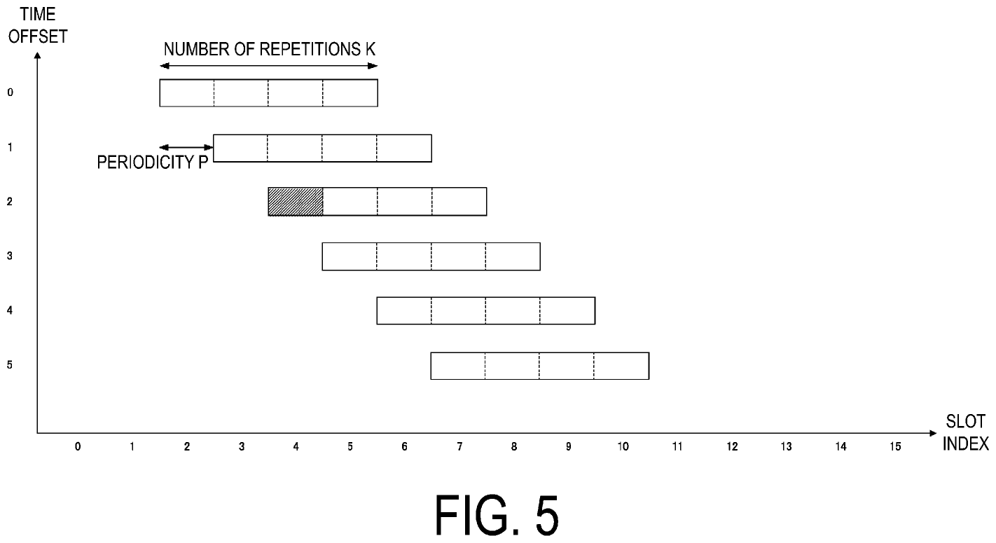

Additionally, as illustrated in FIG. 5, it is assumed that transmission is started at slot index 4 and repeated at slot index 5. In a case that the number of repetitions is four, the remaining two transmissions need to be performed, but in a case that new data is generated, whether to perform the third transmission of the same transport block or to transmit a transport block of the new data needs to be selected. In a case that the number of repetitions is configured to four, two repetitions fail to satisfy prescribed quality, and thus the terminal apparatus determines to perform four transmissions. Accordingly, the terminal apparatus starts transmitting the new data at slot index 8. Even in this case, in a case that different DMRS port numbers are allocated to the respective time offsets as described above, the base station apparatus can recognize the last transmission and the initial transmission and treat received signals as different data. In this way, the same data (transport block) is transmitted during the period for which the repeated transmission is configured based on the configured number of repetitions. This allows the base station to correctly decode the data transmitted by the terminal apparatus.

In the above description, the DMRS port number is changed for each periodicity (constitution, configuration). However, the present embodiment is not limited to the DMRS port number, and any other parameter may be used. For example, like the DMRS port number described above, the HARQ process number may be changed according to the slot number for the start of transmission or the like. This enables different HARQ process IDs to be configured for old data and for new data, thus allowing for correct packet composition at the time of retransmission.

The radio transmitting unit 2070 performs Inverse Fast Fourier Transform (IFFT) on the multiplexed signals to generate OFDM symbols. The radio transmitting unit 2070 adds CPs to the OFDM symbols to generate a baseband digital signal. Furthermore, the radio transmitting unit 2070 converts the baseband digital signal into an analog signal, removes unnecessary frequency components from the analog signal, converts the signal into a signal of a carrier frequency by up-conversion, performs power amplification, and transmits the resultant signal to the base station apparatus 10 via the transmit antenna 208.

The receiver 212 is configured to includes a radio receiving unit (radio receiving step) 2120, a demultiplexing unit (demultiplexing step) 2122, a channel estimation unit (channel estimating step) 2144, an equalization unit (equalizing step) 2126, a demodulation unit (demodulating step) 2128, and a decoding unit (decoding step) 2130.

The radio receiving unit 2120 converts the downlink signal received through the receive antenna 210 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 2120 removes a part corresponding to the CP from the digital signal resulting from the conversion, performs the FFT on the signal from which the CP has been removed, and extracts a signal in the frequency domain.

The demultiplexing unit 2122 separates the extracted signal in the frequency domain into the downlink reference signal, the PDCCH, the PDSCH, and the PBCH. A channel estimation unit 2124 uses the downlink reference signal (such as the DM-RS) to estimate a frequency response (or delay profile). The result of frequency response in the channel estimation for demodulation is input to the equalization unit 1126. The channel estimation unit 2124 measures the uplink channel state (measures a Reference Signal Received Power (RSRP), a Reference Signal Received Quality (RSRQ), a Received Signal Strength Indicator (RSSI), and a Signal to Interference plus Noise power Ratio (SINR)) by using the downlink reference signal (such as the CSI-RS). The measurement of the downlink channel state is used to determine the MCS for the PUSCH and the like. The measurement result of the downlink channel state is used to determine the CQI index and the like.

The equalization unit 2126 generates an equalization weight based on an MMSE criterion, from the frequency response input from the channel estimation unit 2124. The equalization unit 2126 multiplies the input signal (the PUCCH, the PDSCH, the PBCH, and the like) from the demultiplexing unit 2122 by the equalization weight. The demodulation unit 2128 performs demodulation processing based on information of the predetermined modulation order/the modulation order indicated by the controller 204.

The decoding unit 2130 performs decoding processing on the output signal from the demodulation unit 2128 based on information of the predetermined coding rate/the coding rate indicated by the controller 204. The decoding unit 2130 inputs the decoded data (such as the DL-SCH) to the higher layer processing unit 202.

A program running on an apparatus according to an aspect of the present invention may serve as a program that controls a Central Processing Unit (CPU) and the like to cause a computer to operate in such a manner as to realize the functions of the above-described embodiments according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be preferably used in a base station apparatus, a terminal apparatus, and a communication method.

1. A terminal apparatus for communicating with a base station apparatus through configured grant scheduling, the terminal apparatus comprising:
a higher layer processing unit configured to configure higher layer signaling using at least the number of repetitions and an allocation periodicity as parameters for the configured grant scheduling; and
a transmitter configured to transmit a demodulation reference signal (DMRS), wherein
the transmitter determines a port number for the DMRS based on a current number of repetitions.

2. The terminal apparatus according to claim 1, wherein
the transmitter determines the port number for the DMRS based on the current number of repetitions and a slot index.

3. The terminal apparatus according to claim 1, wherein
the transmitter performs transmission until the current number of repetitions reaches the number of repetitions.

4. A base station apparatus for communicating with a terminal apparatus through configured grant scheduling, the base station apparatus comprising:
a higher layer processing unit configured to configure higher layer signaling using at least the number of repetitions and an allocation periodicity as parameters for the configured grant scheduling; and
a receiver configured to receive a demodulation reference signal (DMRS), wherein
the receiver performs reception processing assuming that a port number for the DMRS is determined based on a current number of repetitions.

5. The base station apparatus according to claim 4, wherein
the receiver determines the port number for the DMRS based on the current number of repetitions and a slot index of the terminal apparatus.

6. The base station apparatus according to claim 4, wherein
the receiver performs reception until the current number of repetitions reaches the number of repetitions of the terminal apparatus.
